(19) United States
(12) Patent Application Publication
(10) Pub. No.: US 2025/0284528 A1
(43) Pub. Date: Sep. 11, 2025

(54) INFORMATION PROCESSING METHOD, INFORMATION PROCESSING APPARATUS, AND PROGRAM FOR DETERMINING FUNCTION/OPERATION OF APPLIANCE

(71) Applicant: Panasonic Intellectual Property Corporation of America, Torrance, CA (US)

(72) Inventor: Yuki TAKAOKA, Osaka (JP)

(73) Assignee: Panasonic Intellectual Property Corporation of America, Torrance, CA (US)

(21) Appl. No.: 19/220,073

(22) Filed: May 27, 2025

Related U.S. Application Data
(63) Continuation of application No. PCT/JP2023/033501, filed on Sep. 14, 2023.

(30) Foreign Application Priority Data
Nov. 29, 2022 (JP) 2022-190359

(51) Int. Cl. G06F 9/46; H04L 12/28

(52) U.S. Cl. CPC G06F 9/463; H04L 12/2807

(57) ABSTRACT

A first-type block defined in a functional unit executable by an appliance and a second-type block defined in a unit of operation to be executed by a person are defined. A receiver receives information related to the first-type block executed by the appliance. An estimator estimates a block sequence in which the first-type block and the second-type block are arranged in an order of operation based on the received information related to the first-type block. A modifier modifies, in a case of receiving an instruction to modify the estimated block sequence, the block sequence.

This application is based upon and claims the benefit of priority from the prior Japanese Patent Application No. 2022-190359, filed on Nov. 29, 2022, the entire contents of which are incorporated herein by reference.

### BACKGROUND

### 1. Technical Field

The present disclosure relates to information processing technology, and particularly, to an information processing method, an information processing apparatus, and a program for determining a function/operation of an appliance.

### 2. Description of the Related Art

An operation history of an appliance is effectively utilized to provide a user with appropriate services, such as automatic control of the appliance and provision of information.

For example, if receiving the operation history of the appliance, a service provision apparatus controls the appliance such that the appliance operates according to the operation history (see, for example, JP 2004-185612 A).

A cooking recipe includes not only operations of the appliance but also human intervention. Therefore, control content also including the human intervention as in a cooking recipe cannot be created only by the operation history of the appliance. Meanwhile, it is desirable to easily create the control content also including the human intervention.

### SUMMARY

The present disclosure has been made in view of such a situation, and an object of the present disclosure is to provide a technique for easily creating control content also including human intervention.

In order to solve the above problem, an information processing method according to one aspect of the present disclosure is an information processing method in which a first-type block defined in a functional unit executable by an appliance and a second-type block defined in a unit of operation to be executed by a person are defined, the information processing method including: a step of receiving information related to the first-type block executed by the appliance; a step of estimating a block sequence in which the first-type block and the second-type block are arranged in an order of operation based on the received information related to the first-type block; and a step of modifying the block sequence in a case of receiving an instruction to modify the estimated block sequence.

Another aspect of the present disclosure is an information processing apparatus. The apparatus is an information processing apparatus in which a first-type block defined in a functional unit executable by an appliance and a second-type block defined in a unit of operation to be executed by a person are defined, the information processing apparatus including: a receiver structured to receive information related to the first-type block executed by the appliance; an estimator structured to estimate a block sequence in which the first-type block and the second-type block are arranged in an order of operation based on the received information related to the first-type block; and a modifier structured to modify the block sequence in a case of receiving an instruction to modify the estimated block sequence.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

FIGS. 1A to 1G show configurations of an appliance control system according to an embodiment;

FIGS. 2A to 2E show configurations of the functional blocks used in the appliance control system of FIGS. 1A to 1G;

FIGS. 3A to 3H show configurations of the functional block sequences used in the appliance control system of FIGS. 1A to 1G;

FIG. 4 shows an overview of the operation of the appliance of FIGS. 1A to 1G;

FIG. 5 shows a configuration of the appliance control system of FIGS. 1A to 1G;

FIG. 6 shows a configuration of the appliance of FIG. 5;

FIG. 7 shows a configuration of a user apparatus of FIG. 5;

FIG. 8 shows a configuration of an information processing apparatus of FIG. 5;

FIGS. 9A to 9D show cooking steps when four dishes are cooked at the same time;

FIG. 10 shows a data structure of an execution history DB of FIG. 5;

FIG. 11 shows an execution history displayed on a display of FIG. 7;

FIG. 12 shows a processing overview of a selector of FIG. 8;

FIG. 13 shows a data structure of a sample DB of FIG. 5;

FIG. 14 shows a data structure of a database stored in a storage of FIG. 5;

FIG. 15 shows a processing overview of an estimator of FIG. 8;

FIG. 16 shows a processing overview of a modifier of FIG. 8;

FIG. 17 shows another processing overview of the modifier of FIG. 8;

FIG. 18 is a flowchart showing a procedure for storing the execution history by the appliance control system of FIG. 5; and

FIG. 19 is a flowchart showing a procedure for creating a block sequence by the appliance control system of FIG. 5.

### DETAILED DESCRIPTION

The invention will now be described by reference to the preferred embodiments. This does not intend to limit the scope of the present invention, but to exemplify the invention.

All of the embodiments described below show preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features shown in the figures are denoted by identical symbols, and a duplicate description is omitted or simplified. Hereinafter, the embodiment will be described in the order of (1) overviews of functional blocks and functional block sequences, (2) configurations of appliance control system, (3) storage of execution history, and (4) creation of functional block sequences.

### (1) Overviews of Functional Blocks and Functional Block Sequences

In household electrical/mechanical appliances such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

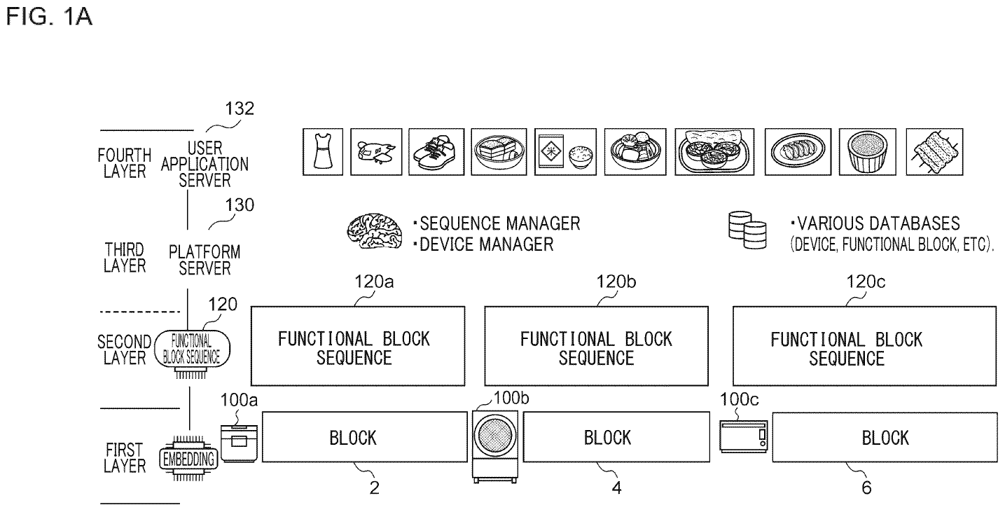

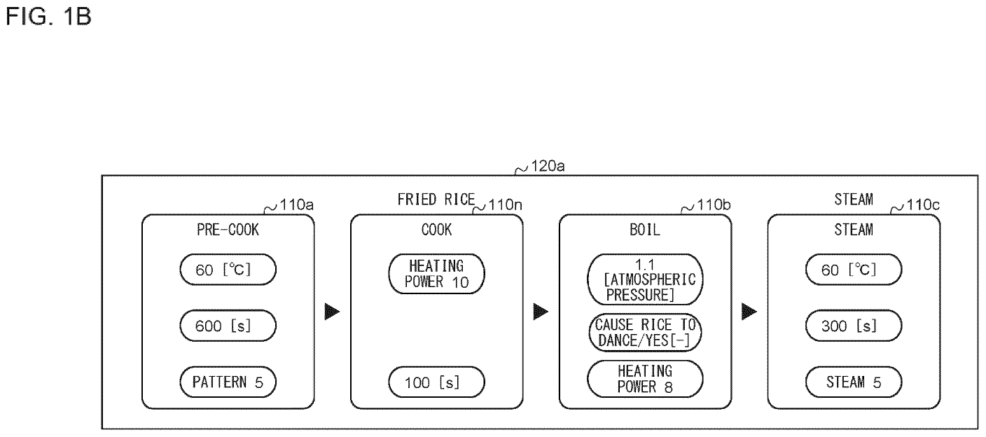

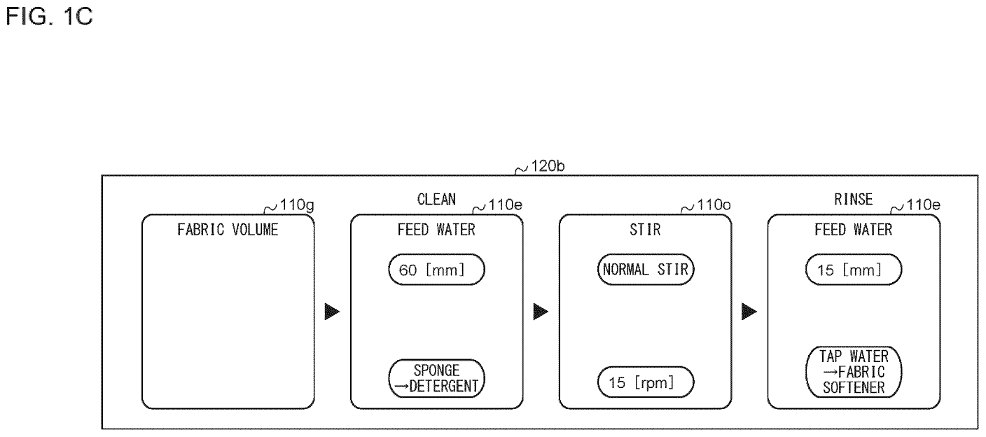

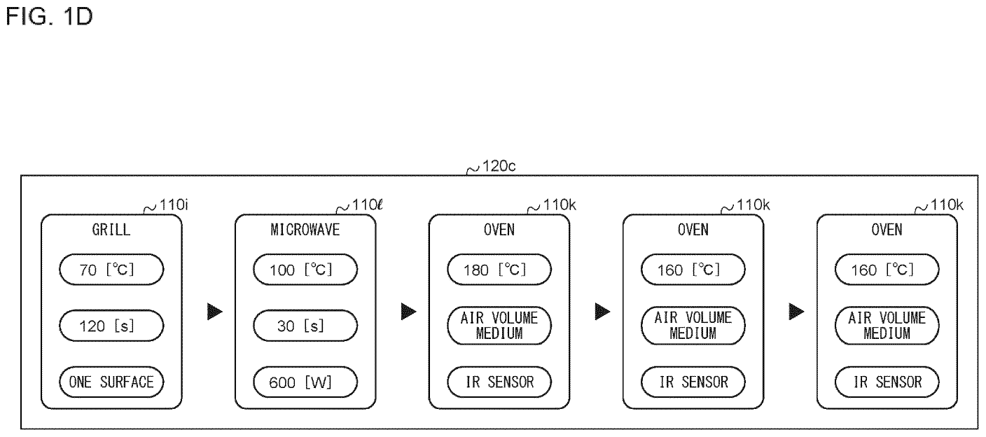

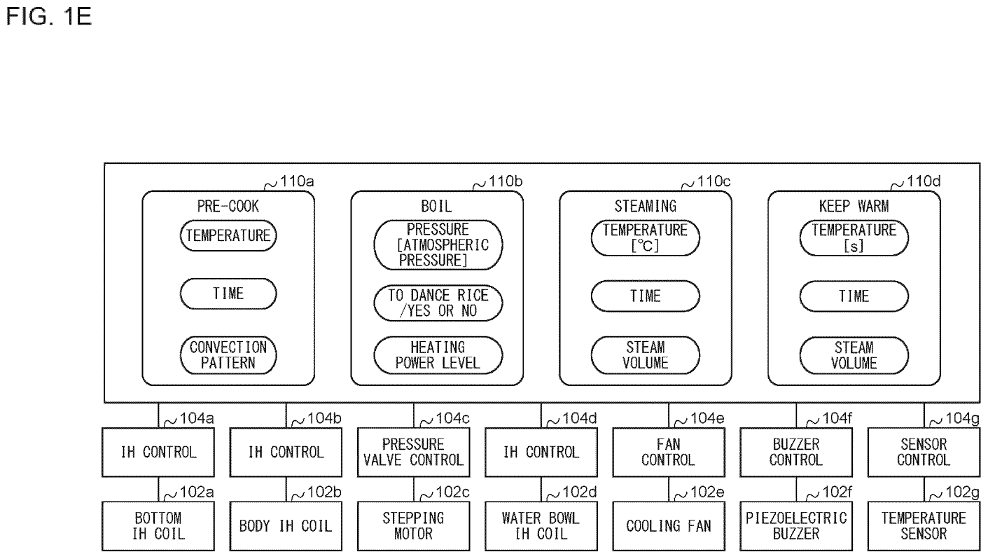

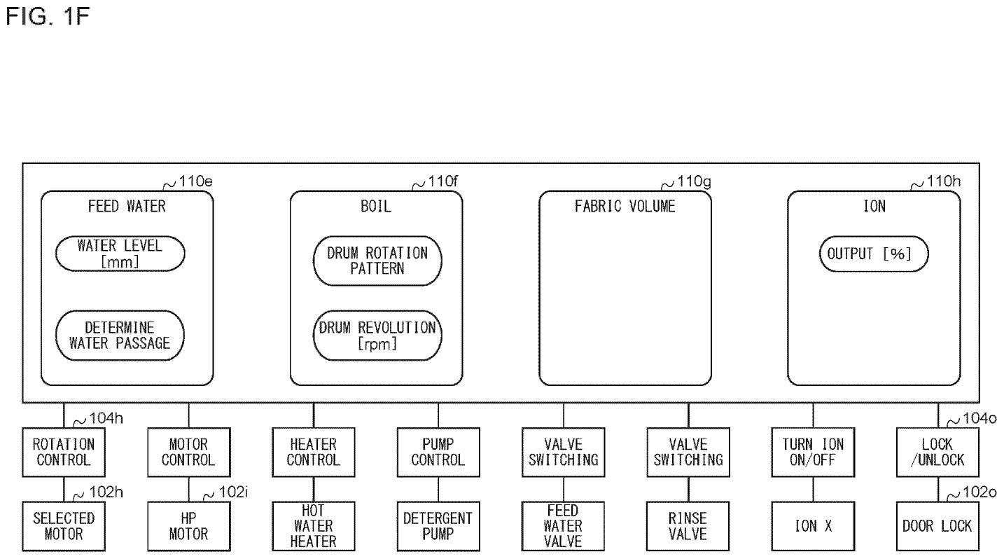

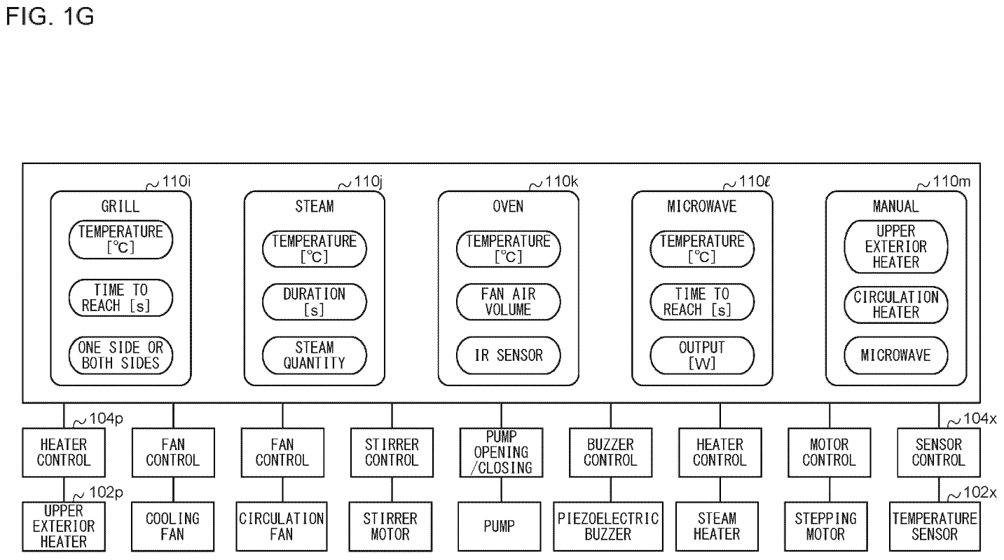

FIGS. 1A to 1G show configurations of an appliance control system 1000. In the appliance control system 1000, a four-layer model composed of the first to fourth layers is defined. In the first layer, the configuration of an appliance 100 is defined. The appliance 100 is, for example, a rice cooker (appliance 100a), a washing machine (appliance 100b), and a microwave oven (appliance 100c). The appliance 100 is not limited thereto. Each appliance 100 includes a block 2 (FIG. 1E), a block 4 (FIG. 1F), a block 6 (FIG. 1G), a plurality of components 102, a plurality of drivers 104, and a plurality of functional blocks 110.

The component 102 is a hardware element constituting a unit derived from dividing the operation (actuation/sensing) of the appliance 100 and includes an actuator and a sensor that execute the function of the appliance 100. The actuator is an output device and the sensor is an input device. The actuator includes, for example, a bottom IH (Induction Heating) coil (component 102a), a body IH coil (component 102b), a stepping motor (component 102c), a water bowl IH coil (component 102d), a cooling fan (component 102e), and a piezoelectric buzzer (component 102f) in the rice cooker (appliance 100a). The sensor is, for example, a temperature sensor (component 102g) in the rice cooker (appliance 100a). The component 102 included in the rice cooker (appliance 100a) is not limited to these, and the washing machine (appliance 100b) and the microwave oven (appliance 100c) are similarly configured.

The driver 104 is software for directly controlling the component 102. IH control (driver 104) in the rice cooker (appliance 100a) controls the bottom IH coil (component 102a). Further, IH control (driver 104b) controls the body IH coil (component 102b), pressure valve control (driver 104c) controls the stepping motor (component 102c), and IH control (driver 104d) controls the water bowl IH coil (component 102d). Further, fan control (driver 104e) controls the cooling fan (component 102e), buzzer control (driver 104f) controls the piezoelectric buzzer (component 102f), and sensor control (driver 104g) controls the temperature sensor (component 102g). The driver 104 included in the rice cooker (appliance 100a) is not limited to these, and the washing machine (appliance 100b) and the microwave oven (appliance 100c) are similarly configured.

The functional block 110 is a software interface (API: Application Programming Interface) associated with one or more drivers 104 to cause one or more components 102 to operate. The functional block 110 can receive one or more parameters for controlling the operation of the (each) component 102. Details of the functional block 110 will be described later.

In the second layer, a functional block sequence 120 in which one or more functional blocks 110 are arranged in the order of operation is defined to cause the appliance 100 to execute an intended process. That is, the functional block sequence 120 defines the order of execution of one or more functional blocks 110. The intended process is defined according to the appliance 100, and is, for example, cooking in the case of the rice cooker (appliance 100a) and the microwave oven (appliance 100c) and washing in the case of the washing machine (appliance 100b). The functional block sequence 120a (FIG. 1B) is used in the rice cooker (appliance 100a), the functional block sequence 120b (FIG. 1C) is used in the washing machine (appliance 100b), and the functional block sequence 120c (FIG. 1D) is used in the microwave oven (appliance 100c). The appliance 100 executes the operation in the order of the functional blocks 110 arranged in the functional block sequence 120. Therefore, it is possible to update the function/operation of the appliance 100 by changing the arrangement of the functional blocks 110 or changing a parameter set in the functional block 110. Details of the functional block sequence 120 will be described later.

In the third layer, a platform server 130 that manages various information in the appliance control system 1000 is arranged. The platform server 130 includes a sequence manager, a device manager, and various databases. The sequence manager manages the functional block sequence 120, the device manager manages the registered information on the appliance 100 that can use the functional block sequence 120, and the various databases manage user information on users who can use the functional block sequence 120.

In the fourth layer, a user application server 132 in which each functional block sequence 120 is presented as a user application is arranged. The functional block sequence 120 presented in the user application server 132 is downloaded to the appliance 100. The downloaded functional block sequence 120 is enabled in the appliance 100. When a further functional block sequence 120 is downloaded to the appliance 100, the further functional block sequence 120 is enabled in the appliance 100.

The third and fourth layers of the appliance control system 1000 may be integrated. In that process, the platform server 130 and the user application server 132 are integrally configured. Alternatively, the third and fourth layers in the appliance control system 1000 may be arranged in the same layer. Alternatively, the third and fourth layers in the appliance control system 1000 may be omitted. In that process, the functional block sequence 120 is downloaded to the appliance 100 from the user apparatus (not shown) owned by the user.

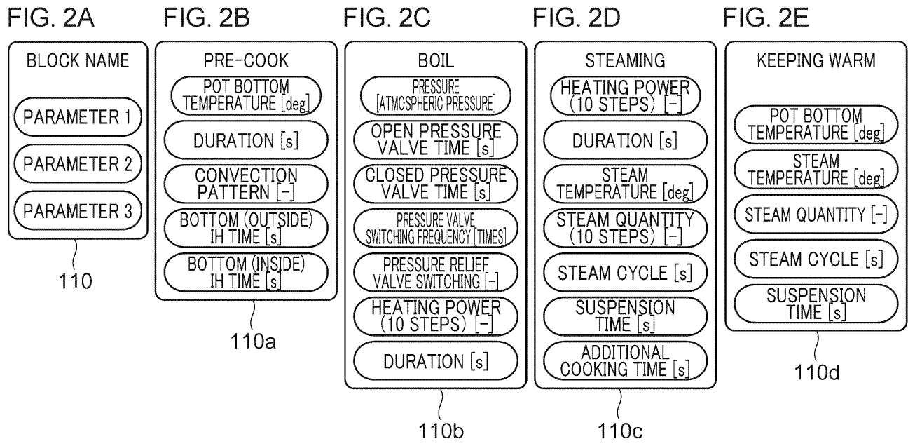

FIGS. 2A to 2E show configurations of the functional block 110 used in the appliance control system 1000. FIG. 2A shows the basic configuration of the functional block 110. The functional block 110 is defined in a functional unit that the appliance 100 can execute and has a “block name” determined by the detail of the function. A plurality of parameters determined by the function can be set in the functional block 110. Each parameter set in the functional block 110 is output to the driver 104. When the driver 104 receives the parameter from the functional block 110, the driver 104 controls the operation of the component 102 according to the parameter.

FIG. 2B shows a functional block 110a of “pre-cook” in the rice cooker (appliance 100a) of FIG. 1A. In the functional block 110a of “pre-cook”, parameters including pot bottom temperature, duration, convection pattern, bottom (outside) IH time, and bottom (inside) IH time can be set. FIG. 2C shows a functional block 110b of “boil” in the rice cooker (appliance 100a) of FIG. 1A, FIG. 2D shows a functional block 110c of “steam” in the rice cooker (appliance 100a) of FIG. 1A, and FIG. 2E shows a functional block 110d of “keep warm”. A plurality of parameters can be set in each of the functional block 110b to the functional block 110d as well. The same applies to the functional block 110 in the washing machine (appliance 100b) and the microwave oven (appliance 100c) of FIG. 1A.

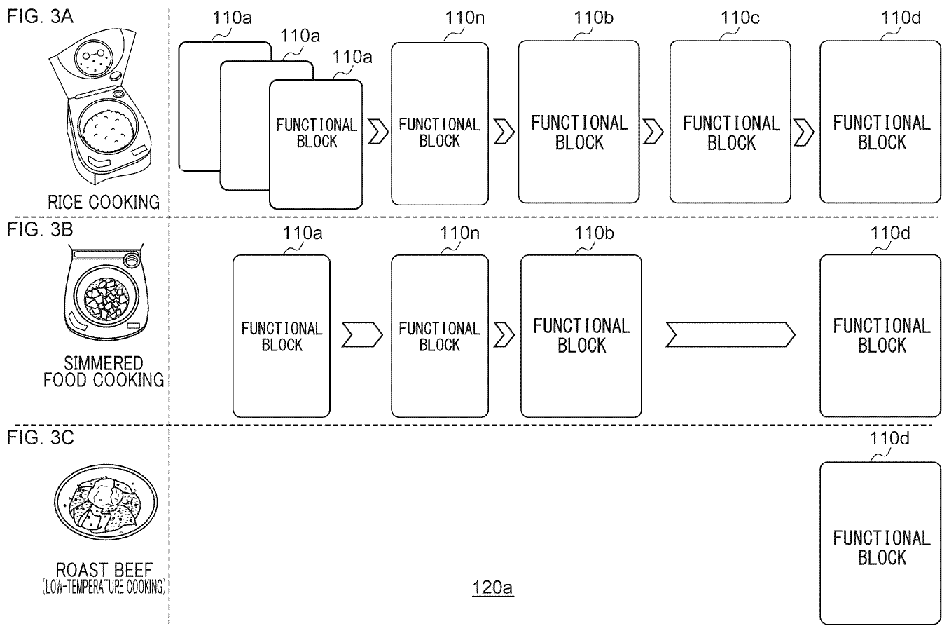

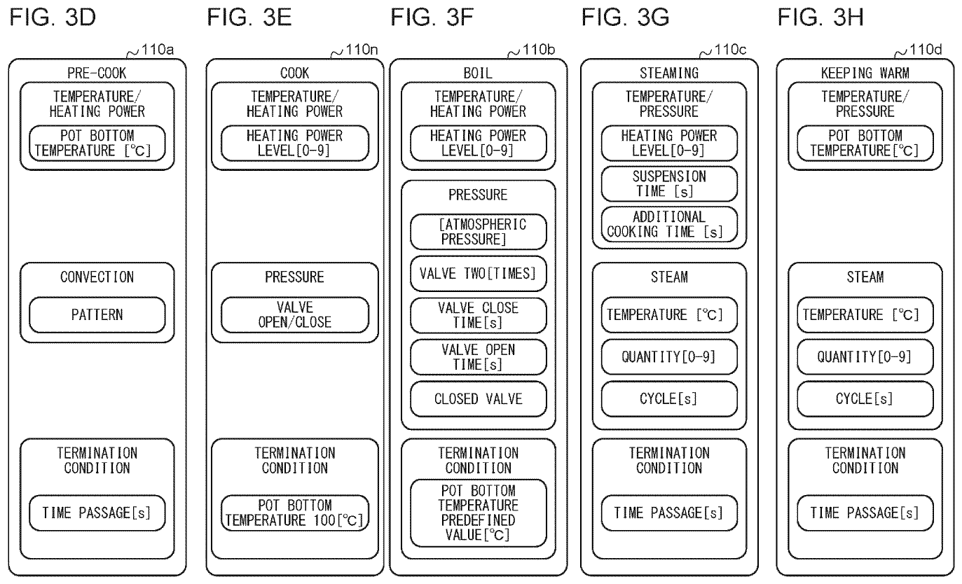

FIGS. 3A to 3H show configurations of the functional block sequence 120 used in the appliance control system 1000 and, particularly, the functional block sequence 120a used in the rice cooker (appliance 100a) of FIG. 1A. FIG. 3A shows a sequence for “rice cooking”, FIG. 3B shows a sequence for “simmered food cooking”, and FIG. 3C shows a sequence for “roast beef (low temperature cooking)”.

In the sequence for “rice cooking” shown in FIG. 3A, three “pre-cook” functional blocks 110a (FIG. 3D), a “cook” functional block 110n (FIG. 3E), the “boil” functional block 110b (FIG. 3F), the “steam” functional block 110c (FIG. 3G), and the “keep warm” functional block 110d (FIG. 3H) are arranged in order. In the three “pre-cook” functional blocks 110a, mutually different parameters are set. By thus arranging the three “pre-cook” functional blocks 110a in which mutually different parameters are set in order, a three-step pre-cooking can be executed.

In the sequence for “simmered food cooking” shown in FIG. 3B, the “pre-cook” functional block 110a, the “cook” functional block 110n, the “boil” functional block 110b, and the “keep warm” functional block 110d are arranged in order. The sequence for “roast beef (low temperature cooking)” shown in FIG. 3C includes the “keep warm” functional block 110d. By thus changing the type, arrangement, and parameters of the functional block 110 used, it is possible to execute processes directed to different purposes of “rice cooking”, “simmered food cooking”, and “roast beef (low-temperature cooking)”. The same applies to the functional block sequence 120 in the washing machine (appliance 100b) and the microwave oven (appliance 100c) of FIG. 1A.

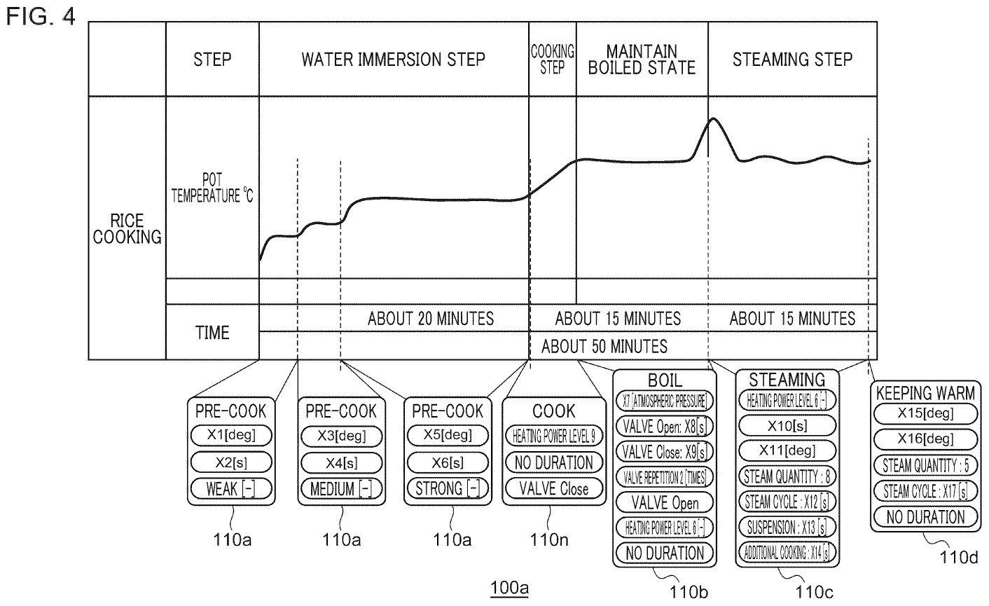

FIG. 4 shows an overview of the operation of the appliance 100 and, particularly, the rice cooker (appliance 100a) of FIG. 1A. This shows the operation of the appliance 100a according to the sequence for “rice cooking” in FIG. 3A. In the water immersion step, the three “pre-cook” functional blocks 110a with mutually different parameters set are executed in order so that the components 102 corresponding to them operate according to the parameters. As a result, the pot temperature increases in a stepwise manner over time. Following this, the “cook” functional block 110n, the “boil” functional block 110b, the “steam” functional block 110c, and the “keep warm” functional block 110d are executed in order so that the components 102 corresponding to them operate according to the parameters. That is, rice is cooked in the appliance 100a by executing a plurality of functional blocks 110 in order.

In the description given so far, the functional block 110 is defined in a functional unit that can be executed by the appliance 100, and the functional block sequence 120 in which one or more functional blocks 110 are arranged in the order of operation is defined. Such functional blocks 110 do not include an operation to be executed by a person. On the other hand, in an actual intended process, the operation to be executed by a person may also be required. To address this, the functional block 110 and the functional block sequence 120 described so far are expanded in the following. Therefore, the functional block 110 is also defined in a unit of operation to be executed by a person. By expressing the operation of the person as the functional block 110, the operation of the person can be dealt with in the same way as the operation of the appliance 100. In addition, the functional block 110 defined in the functional unit that can be executed by the appliance 100 is defined as a “first-type block”, and the functional block 110 defined in the unit of the operation to be executed by the person is defined as a “second-type block”. Hereinafter, the functional block 110 is used without distinguishing between the first-type block and the second-type block.

### (2) Configuration of Appliance Control System

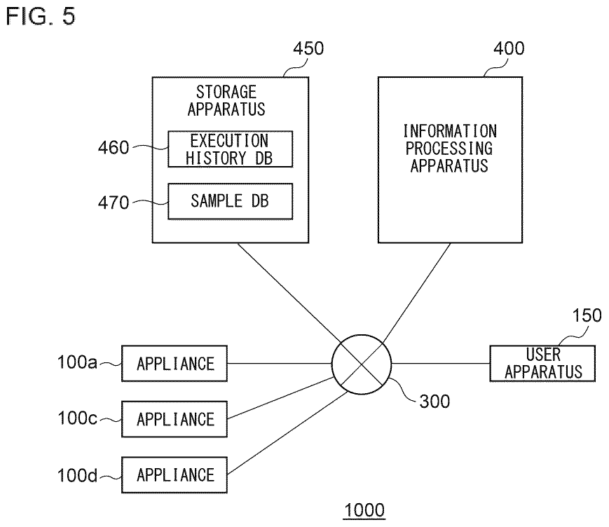

FIG. 5 shows the configuration of the appliance control system 1000. The appliance control system 1000 includes the appliance 100a, the appliance 100c, an appliance 100d, a user apparatus 150, a network 300, an information processing apparatus 400, and a storage apparatus 450. In addition, the storage apparatus 450 includes an execution history DB 460 and a sample DB 470.

The appliance 100a and the appliance 100c are, for example, the rice cooker and the microwave oven of FIG. 1A. The appliance 100d is, for example, an IH cooking heater. Each appliance 100 executes processes of the first layer and the second layer of FIGS. 1A and 1s connected to the network 300. In addition to the appliance 100, the user apparatus 150, the information processing apparatus 400, and the storage apparatus 450 are also connected to the network 300. In the network 300, any one of wired communication, wireless communication, and a combination of the wired communication and the wireless communication is executed between these apparatuses.

The user apparatus 150 is an apparatus used by a user who executes an intended process, for example, cooking, and is, for example, a computer, a smartphone, or a tablet terminal. The user apparatus 150 receives, from the user, information related to a dish to be cooked in the appliance 100. The user apparatus 150 transmits the information related to the dish to the information processing apparatus 400 via the network 300.

The information processing apparatus 400 is, for example, a server including a processor, a memory, and the like, or a computer such as a cloud server. In addition, the information processing apparatus 400 is also a user application server 132 for executing the process of the fourth layer of FIG. 1A. If receiving the information related to the dish from the user apparatus 150, the information processing apparatus 400 selects the functional block sequence 120 corresponding to the dish, and transmits information on the functional block sequence 120 to the appliance 100 via the network 300. If receiving the information on the functional block sequence 120 from the information processing apparatus 400, the appliance 100 executes an operation according to the functional block sequence 120.

In addition to such process, the information processing apparatus 400 creates and updates the functional block sequence 120 in cooperation with the storage apparatus 450. At that time, the user inputs various information using the user apparatus 150. The information input by the user is reflected when the information processing apparatus 400 creates the functional block sequence 120.

The storage apparatus 450 is, for example, a hard disk drive (HDD), or a solid state drive (SSD), and is a storage region that can store electronic information. The execution history DB 460 stores an execution history of the functional block 110 in each appliance 100, and the sample DB 470 stores a sample of the functional block sequence 120 for various recipes.

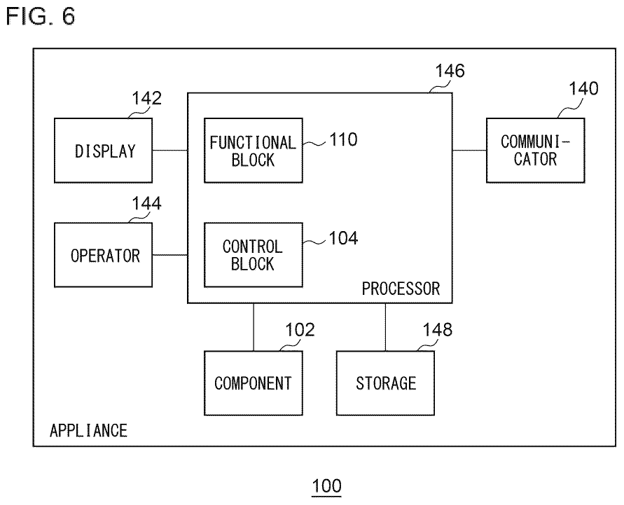

FIG. 6 shows a configuration of the appliance 100. The appliance 100 includes the component 102, a communicator 140, a display 142, an operator 144, a processor 146, and a storage 148. The processor 146 includes the functional block 110 and the driver 104. As described above, the appliance 100 is a household electrical/mechanical appliance such as a rice cooker, a washing machine, or a microwave oven. A plurality of components 102, a plurality of drivers 104, and a plurality of functional blocks 110 are provided as shown in FIGS. 1B to 1G, but only a respective one is shown here for the sake of clarity of the drawings.

The communicator 140 is connected to the network 300 and executes communication with the information processing apparatus 400 via the network 300. For example, the communicator 140 receives the information on the functional block sequence 120 from the information processing apparatus 400. The functional block sequence 120 includes the functional block 110 to be executed by the appliance 100 in the functional block sequence 120 for the intended process. In addition, the storage 148 stores the functional block 110 that can be executed in the appliance 100. The processor 146 reads out the functional block 110 stored in the storage 148 based on the information on the functional block sequence 120 received by the communicator 140, and causes the component 102 to execute the process according to the functional block sequence 120 via the driver 104.

The display 142 displays information from the processor 146. The operator 144 is an interface capable of receiving an input from a user, and is, for example, a button. In addition, the display 142 and the operator 144 may be integrated as a touch panel. The operator 144 outputs the received input to the processor 146.

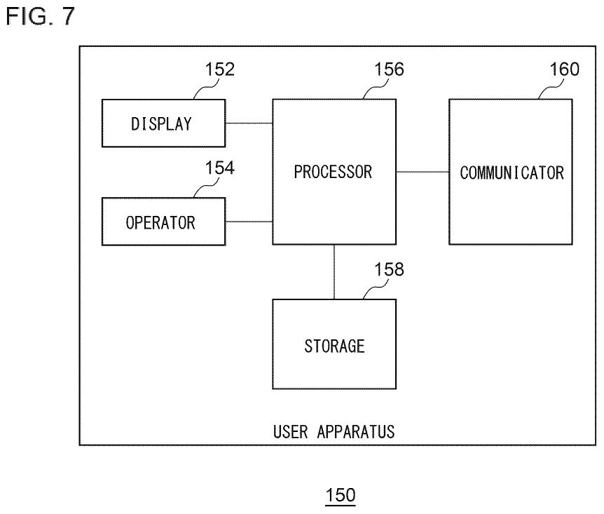

FIG. 7 shows a configuration of the user apparatus 150. The user apparatus 150 includes a display 152, an operator 154, a processor 156, a storage 158, and a communicator 160. As described above, the user apparatus 150 is a computer, a smartphone, or a tablet terminal. The display 152 displays information received from the processor 156. The operator 154 is an interface capable of receiving an input from a user, and is, for example, a button. In addition, the display 152 and the operator 154 may be integrated as a touch panel. The operator 154 outputs the received input to the processor 156.

The processor 156 outputs the information to be displayed to the display 152 and receives the input from the operator 154. In addition, the processor 156 also stores the information in the storage 158 and reads out the information from the storage 158. Further, the processor 156 is connected to the network 300 via the communicator 160 and executes the communication with the information processing apparatus 400 via the network 300. With such configuration, if the operator 154 receives predetermined information from the user, the processor 156 transmits the predetermined information from the communicator 160 to the information processing apparatus 400.

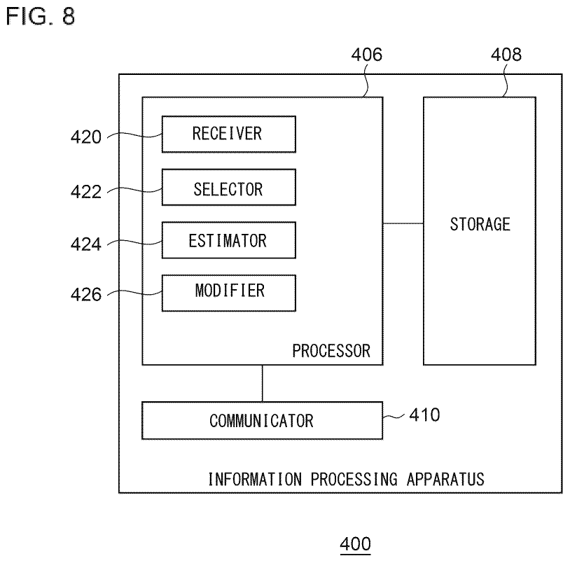

FIG. 8 shows a configuration of the information processing apparatus 400. The information processing apparatus 400 includes a processor 406, a storage 408, and a communicator 410. The processor 406 includes a receiver 420, a selector 422, an estimator 424, and a modifier 426.

The processor 406 executes the process in the information processing apparatus 400, for example, the process of creating the functional block sequence 120. Details of the process in the processor 406 will be described later. The storage 408 stores information used in the processor 406. The communicator 410 is connected to the network 300 and communicates with the appliance 100, the user apparatus 150, and the storage apparatus 450 via the network 300.

### (3) Storage of Execution History

As described above, the functional block sequence 120 can be freely created by arranging the plurality of functional blocks 110. However, the user does not understand the operation of each component 102 in detail. Therefore, it is difficult to understand which functional block 110 is combined to implement the operation suitable for a demand of the user. As a result, it is difficult to create the functional block sequence 120.

For such user, it is desirable that the functional block sequence 120 be created to reproduce his/her actual cooking. For example, the functional block sequence 120 is created by storing the functional blocks 110 executed in the appliance 100 during the actual cooking and arranging the functional blocks 110 in an order of execution. However, the actual cooking includes not only the operation of the appliance 100 but also the operation of the user, but the functional block 110 associated with the operation of the user cannot be stored. Therefore, in the process as described above, it is impossible to create the functional block sequence 120 that reproduces cooking.

In addition, even if the user desires to create a recipe (functional block sequence 120) after the cooking, it is difficult to create the functional block sequence 120 since no executed functional block 110 is stored. Further, in the cooking, not only one dish but also a plurality of dishes may be cooked at the same time. In that case, the functional blocks 110 corresponding to each of the plurality of dishes are combined, and thus, it is difficult to create the functional block sequence 120 corresponding to one dish. In the present embodiment, the functional block sequence 120 is estimated from the functional blocks 110 executed in each of the plurality of the appliances 100, and creation of the functional block sequence 120 is supported. Such functional block sequence 120 corresponds to the recipe.

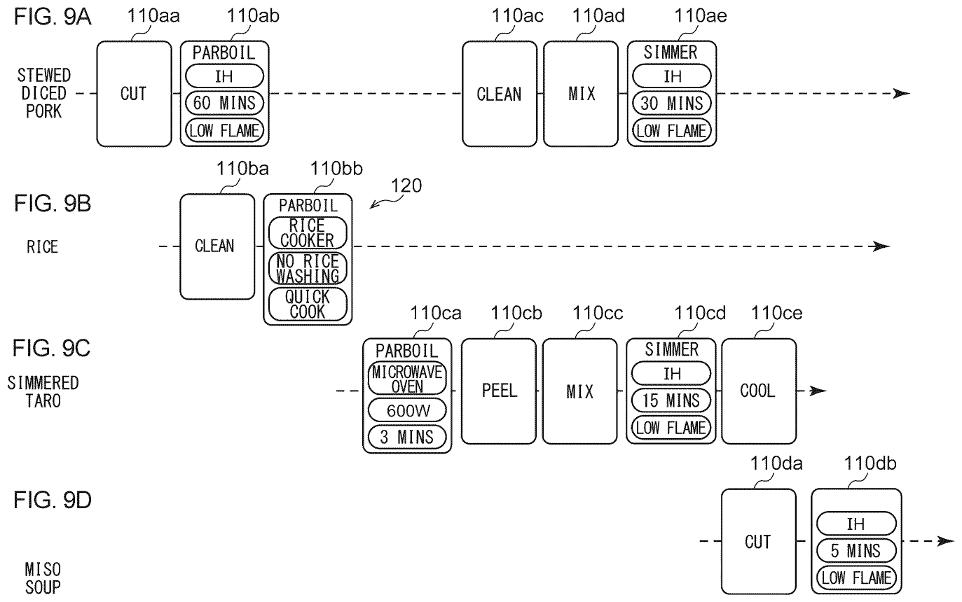

FIGS. 9A to 9D show cooking steps when four dishes are cooked at the same time. Here, it is assumed a case where rice, a simmered taro, and miso soup are cooked at the same time in addition to stewed diced pork. FIG. 9A shows a stewed diced pork cooking step. In the stewed diced pork cooking step, a “cut” functional block 110aa, a “parboil” functional block 110ab, a “clean” functional block 110ac, a “mix” functional block 110ad, and a “simmer” functional block 110ae are executed in order. Here, the “cut” functional block 110aa, the “clean” functional block 110ac, and the “mix” functional block 110ad are executed by a person. The “parboil” functional block 110ab and the “simmer” functional block 110ae are executed by the IH cooking heater (appliance 100d).

FIG. 9B shows a rice cooking step. In the rice cooking process, a “clean” functional block 110ba and a “rice cooking” functional block 110bb are executed in order. Here, the “clean” functional block 110ba is executed by a person, and the “rice cooking” functional block 110bb is executed by the rice cooker (appliance 100a).

FIG. 9C shows a simmered taro cooking step. In the simmered taro cooking process, a “parboil” functional block 110ca, a “peel” functional block 110cb, a “mix” functional block 110cc, a “simmer” functional block 110cd, and a “cool” functional block 110ce are executed in order. Here, the “parboil” functional block 110ca is executed by the microwave oven (appliance 100c), the “peel” functional block 110cb, the “mix” functional block 110cc, and the “cool” functional block 110ce are executed by a person, and the “simmer” functional block 110cd is executed by the IH cooking heater (appliance 100d).

FIG. 9D shows a miso soup cooking step. In the miso soup cooking step, a “cut” functional block 110da and a “simmer” functional block 110db are executed in order. Here, the “cut” functional block 110da is executed by a person, and the “simmer” functional block 110db is executed by the IH cooking heater (appliance 100d).

After completion of the cooking, the rice cooker (appliance 100a) reports, to the information processing apparatus 400 via the network 300, that the “rice cooking” functional block 110bb has been executed. The microwave oven (appliance 100c) reports, to the information processing apparatus 400 via the network 300, that the “parboil” functional block 110ca has been executed. The IH cooking heater (appliance 100d) reports, to the information processing apparatus 400 via the network 300, that the “cut” functional block 110aa or the like has been executed. Each report includes user identification information for identifying a user (home).

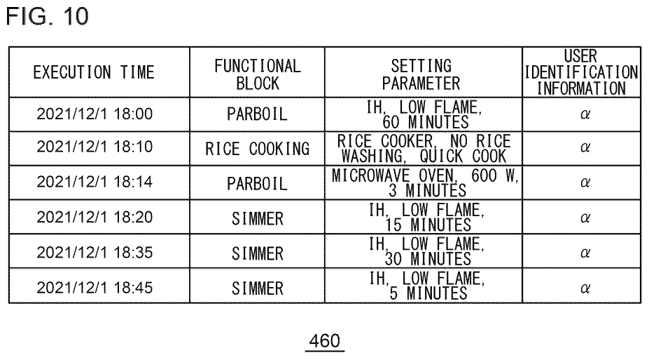

If receiving the reports from the rice cooker (appliance 100a), the microwave oven (appliance 100c), and the IH cooking heater (appliance 100d), the information processing apparatus 400 stores each report in the execution history DB 460. FIG. 10 shows a data structure of the execution history DB 460. In the execution history DB 460, execution time, a name of the executed functional block 110, a setting parameter in the functional block 110, and the user identification information are stored for each report. Such reports are intermingled for a plurality of dishes and a plurality of appliances 100. In addition, in a case where the execution history DB 460 stores reports from the appliances 100 used by a plurality of users, the user identification information is used to identify a transmission source of each report. In this way, the execution history DB 460 can store information related to the functional block 110 executed by the appliance 100, but cannot store information related to the functional block 110 executed by a person.

### (4) Creation of Functional Block Sequences

Here, a case is assumed where the user desires to leave the recipe of the stewed diced pork as the functional block sequence 120 after the completion of the cooking of the stewed diced pork, the rice, the simmered taro, and the miso soup as described above. Therefore, here, a process of creating the functional block sequence 120 of the stewed diced pork will be described. The user manipulates the operator 154 of the user apparatus 150 to input an instruction (hereinafter, referred to as a “creation start instruction”) to start creation of the functional block sequence 120. The creation start instruction includes the user identification information. The communicator 160 transmits the creation start instruction to the information processing apparatus 400 via the network 300.

The communicator 410 of the information processing apparatus 400 receives the creation start instruction from the user apparatus 150. If the receiver 420 receives the creation start instruction, the processor 406 accesses the execution history DB 460 via the communicator 410 to acquire an execution history (one or more reports) for the user identification information included in the creation start instruction. In response to this, the receiver 420 receives the execution history from the execution history DB 460 via the communicator 410. The execution history can be said to be the information related to the functional block 110 (first-type block) executed by the appliance 100. The communicator 410 transmits the execution history to the user apparatus 150 via the network 300.

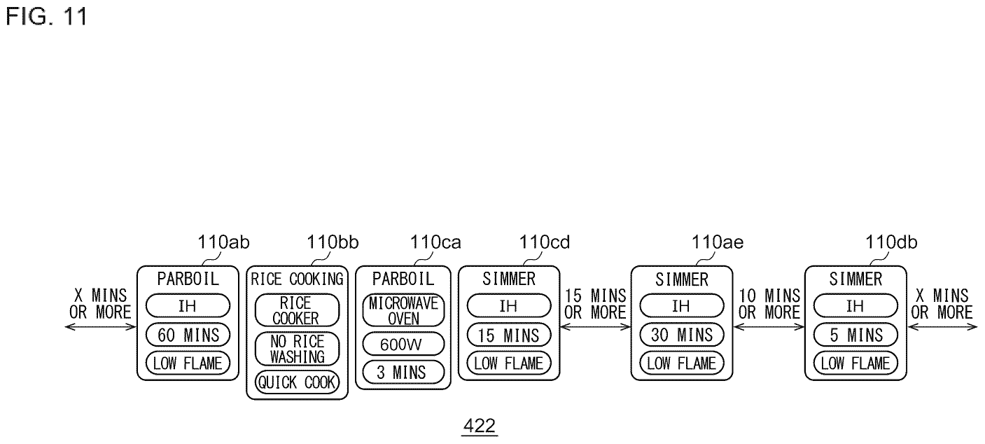

The communicator 160 of the user apparatus 150 receives the execution history from the information processing apparatus 400. The processor 156 displays the execution history on the display 152. FIG. 11 shows an execution history displayed on the display 152. The plurality of functional blocks 110 executed in each appliance 100 are arranged in an order of the execution time. For example, the “parboil” functional block 110ab, the “rice cooking” functional block 110bb, the “parboil” functional block 110ca, and the “simmer” functional block 110cd are arranged in order from the front. In addition, the “simmer” functional block 110ae is arranged after 15 minutes or more from the “simmer” functional block 110cd. Further, the “simmer” functional block 110db is arranged after 10 minutes or more from the “simmer” functional block 110ae.

As described above, since the user desires to leave the stewed diced pork recipe as the functional block sequence 120, the user manipulates the operator 154 of the user apparatus 150 to select the functional block 110 included in the stewed diced pork recipe from the plurality of functional blocks 110 displayed as shown in FIG. 11. The processor 156 receives information on the functional block 110 selected by the user. The communicator 160 transmits the information on the selected functional block 110 to the information processing apparatus 400 via the network 300.

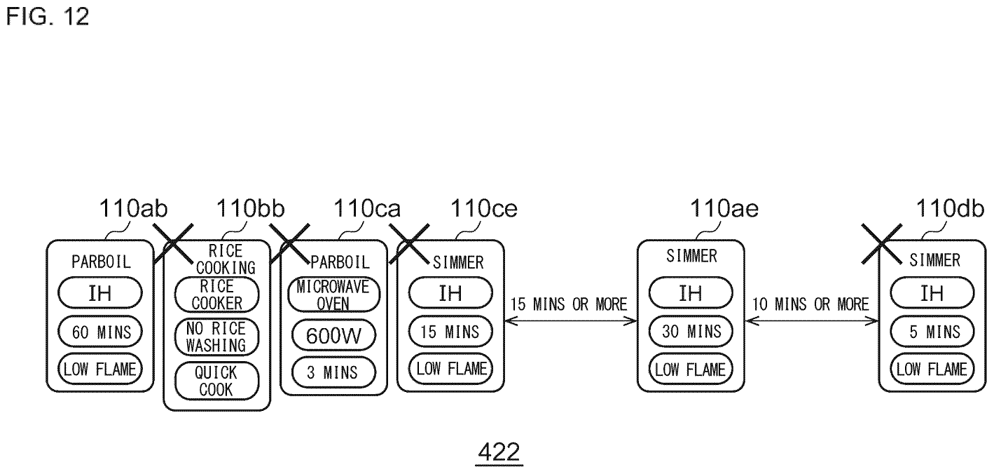

The communicator 410 of the information processing apparatus 400 receives the information on the selected functional block 110 from the user apparatus 150. The receiver 420 receives the information on the selected functional block 110. The selector 422 selects one or more functional blocks 110 from the plurality of functional blocks 110 included in the execution history according to the information on the selected functional block 110. This corresponds to selecting the functional block 110 corresponding to one recipe (stewed diced pork) among a plurality of recipes from the plurality of functional blocks 110 included in the execution history. FIG. 12 shows a processing overview of the selector 422. Among the plurality of functional blocks 110 shown in FIG. 11, the “parboil” functional block 110ab and the “simmer” functional block 110ae included in a stewed diced pork recipe are selected.

As described above, the user manipulates the operator 154 of the user apparatus 150 to select the functional block 110, but may further input information related to an executed recipe. The information related to the executed recipe is, for example, at least one of a recipe name, a recipe category, and main ingredients, but is not limited thereto. The processor 156 receives the information related to the executed recipe. The communicator 160 transmits the information related to the executed recipe to the information processing apparatus 400 via the network 300. The communicator 410 of the information processing apparatus 400 receives the information related to the executed recipe from the user apparatus 150. The receiver 420 receives the information related to the executed recipe.

The functional block 110 selected by the selector 422 is the functional block 110 executed by the appliance 100. Therefore, in order to reproduce the recipe by the plurality of functional blocks 110, the functional blocks 110 executed by a person are insufficient. Based on the selected functional block 110, the estimator 424 estimates the functional block sequence 120 in which the functional block 110 defined in the functional unit executable by the appliance 100 and the functional block 110 defined in the unit of the operation to be executed by the person are arranged in the order of operation. The estimator 424 uses the sample DB 470 for the estimation.

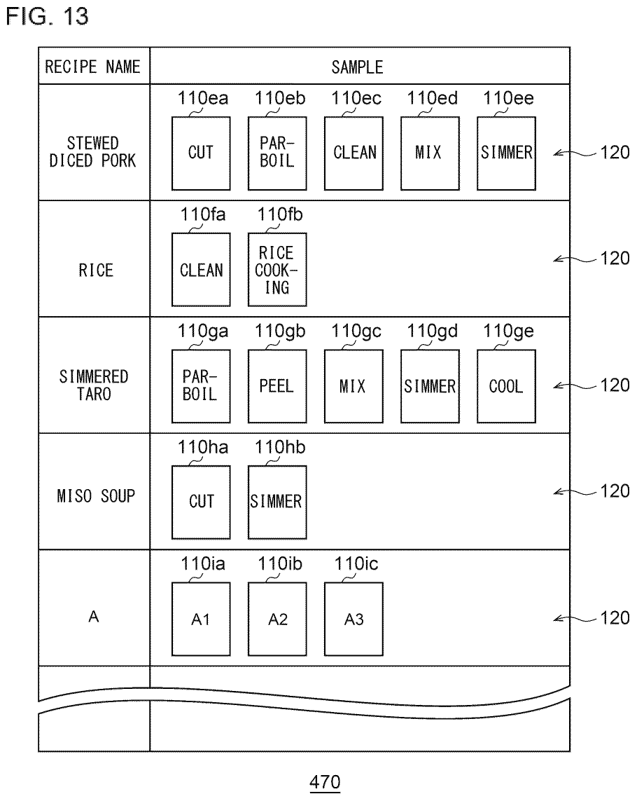

FIG. 13 shows a data structure of the sample DB 470. The sample DB 470 stores a sample of the functional block sequence 120 for each of the plurality of recipes. For example, “stewed diced pork”, “rice”, “simmered taro”, “miso soup”, “A”, and the like are shown as recipe names, and the plurality of functional blocks 110 included in the sample of the functional block sequence 120 are shown respectively. Here, the sample of the functional block sequence 120 is associated with the recipe names, but may be associated with the recipe categories and the main ingredients.

The estimator 424 acquires the sample of the functional block sequence 120 corresponding to the recipe indicated in the information related to the recipe by referring to the sample DB 470 based on the information related to the recipe received by the receiver 420. In addition, the estimator 424 specifies the functional block 110 corresponding to the functional block 110 selected by the selector 422 among the plurality of functional blocks 110 included in the acquired sample of the functional block sequence 120. The functional block 110 corresponding to the selected functional block 110 is the same functional block 110 as the selected functional block 110 or a functional block 110 similar to the selected functional block 110.

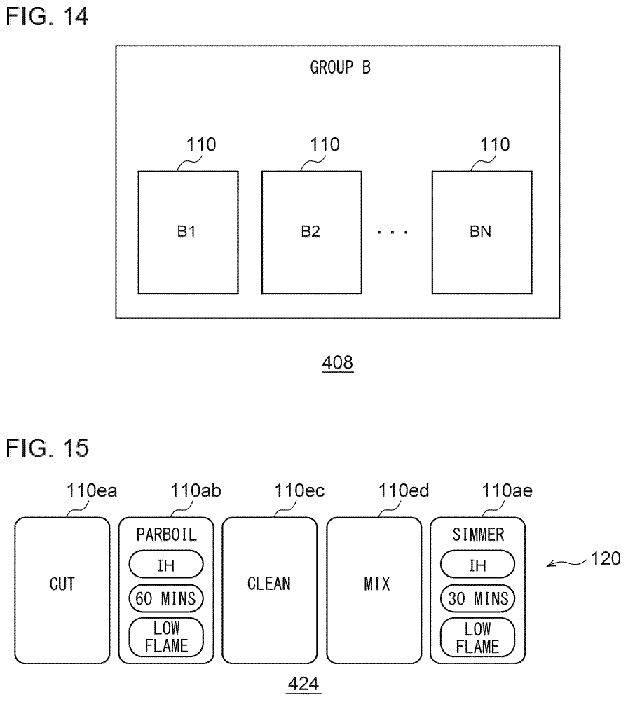

FIG. 14 is used herein to describe the process of identifying the functional block 110 similar to the selected functional block 110. FIG. 14 shows a data structure of a database stored in the storage 408. The functional block 110 of “B1”, the functional block 110 of “B2”, . . . , and the functional block 110 of “BN” having similar functions are grouped as a “group B”. A plurality of types of such groups are defined. It can be said that other functional blocks 110 in the group including the selected functional block 110 are functional blocks 110 similar to the selected functional block 110.

FIG. 15 shows a processing overview of the estimator 424. This indicates the functional block sequence 120 estimated by the estimator 424. A “cut” functional block 110ea, a “parboil” functional block 110ab, a “clean” functional block 110ec, a “mix” functional block 110ed, and a “simmer” functional block 110ae are arranged in order from the front. Here, the “parboil” functional block 110ab and the “simmer” functional block 110ae are the functional blocks 110 included in the execution history, and the “cut” functional block 110ea, the “clean” functional block 110ec, and the “mix” functional block 110ed are the functional blocks 110 estimated by the estimator 424. By such process, the functional block sequence 120 also including the functional block 110 associated with the operation of the user is estimated from the functional block 110 associated with the operation of the appliance 100.

In a case where the user does not input the information related to the executed recipe to the user apparatus 150, the receiver 420 of the information processing apparatus 400 does not receive the information related to the executed recipe. In a case where the receiver 420 does not receive the information related to the executed recipe, the estimator 424 acquires the sample of the functional block sequence 120 including a pattern by referring to the sample DB 470 based on the pattern in which the functional blocks 110 selected by the selector 422 are arranged. That is, the estimator 424 acquires the sample of the functional block sequence 120 including the same pattern as the pattern in which the functional blocks 110 selected by the selector 422 are arranged. At that time, the estimator 424 may use information on a time interval between the selected functional blocks 110. In addition, information on the ingredients, the appliance 100, and information on the setting parameters (strength/time) may be used. A subsequent process may be the same as before, and the estimator 424 estimates the functional block sequence 120 as shown in FIG. 15. The communicator 410 transmits the information on the functional block sequence 120 estimated by the estimator 424 to the user apparatus 150 via the network 300.

The communicator 160 of the user apparatus 150 receives the information on the functional block sequence 120 from the information processing apparatus 400. The processor 156 displays the information on the functional block sequence 120 as shown in FIG. 15 on the display 152. The user manipulates the operator 154 to input a modification instruction for the functional block sequence 120 while looking at the functional block sequence 120 displayed on the display 152. The modification instruction is, for example, deletion or change of the functional block 110 included in the functional block sequence 120, addition of the functional block 110 to the functional block sequence 120, or input of a setting parameter (for example, an ingredient or a gram).

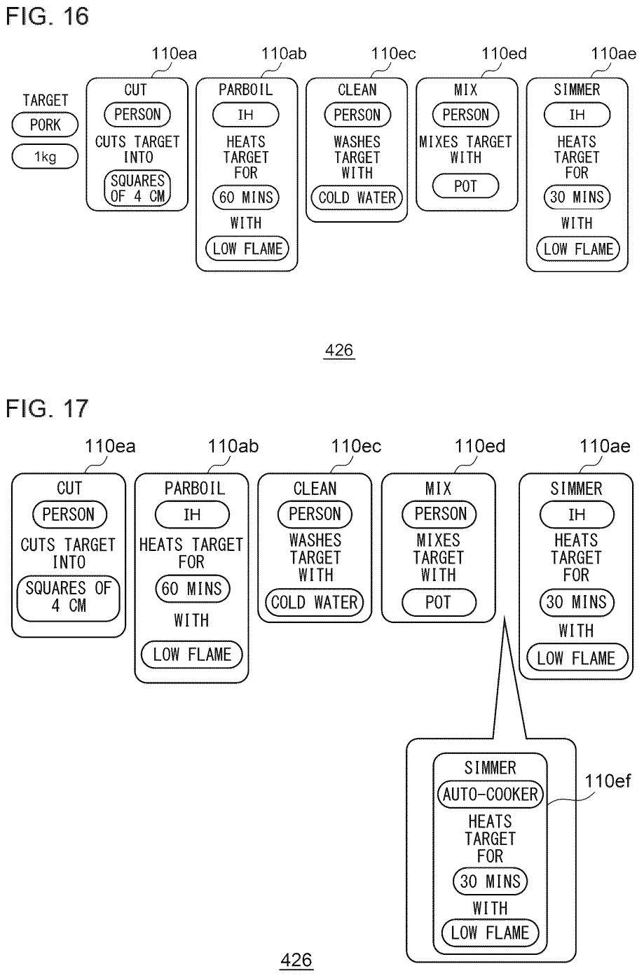

The processor 156 receives the modification instruction. The communicator 160 transmits the modification instruction to the information processing apparatus 400 via the network 300. The communicator 410 of the information processing apparatus 400 receives the modification instruction from the user apparatus 150. The receiver 420 receives the modification instruction. In a case of receiving the modification instruction, the modifier 426 modifies the functional block sequence 120 according to the modification instruction. FIG. 16 shows a processing overview of the modifier 426. Here, as an example, a setting parameter is added to the functional block 110ea and the like in the functional block sequence 120 shown in FIG. 15. The modification in the modifier 426 is not limited thereto.

The modifier 426 may specify a functional block 110 similar to the functional block 110 included in the functional block sequence 120, that is, a functional block 110 having an equivalent function with reference to the table of FIG. 14, and propose conversion into such functional block 110. FIG. 17 shows another processing overview of the modifier 426. Here, a “simmer” functional block 110ef having an equivalent function to the “simmer” functional block 110ae is a candidate for the conversion. The conversion is proposed on the display 152 of the user apparatus 150, and in a case of the conversion, the user inputs a conversion instruction to the operator 154 of the user apparatus 150. If the receiver 420 of the information processing apparatus 400 receives the conversion instruction, the modifier 426 converts the functional block 110. In a case where the functional block sequence 120 is modified, the storage 408 stores both the functional block sequence 120 before the modification and the functional block sequence 120 after the modification.

The features are implemented in hardware such as a Central Processing Unit (CPU), a memory, or other Large Scale Integrations (LSIs) of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

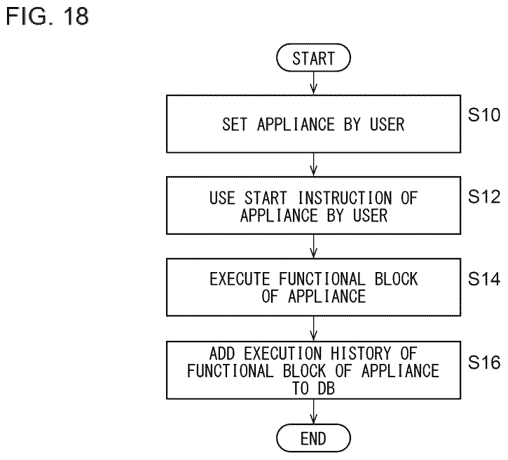

An operation of the appliance control system 1000 having the above configuration will be described. FIG. 18 is a flowchart showing a procedure for storing an execution history by the appliance control system 1000. The user sets the appliance 100 (S10). The user instructs the appliance 100 to start using the appliance 100 (S12). The functional block 110 is executed in the appliance 100 (S14). The appliance 100 adds the execution history of the functional block 110 to the execution history DB 460 (S16).

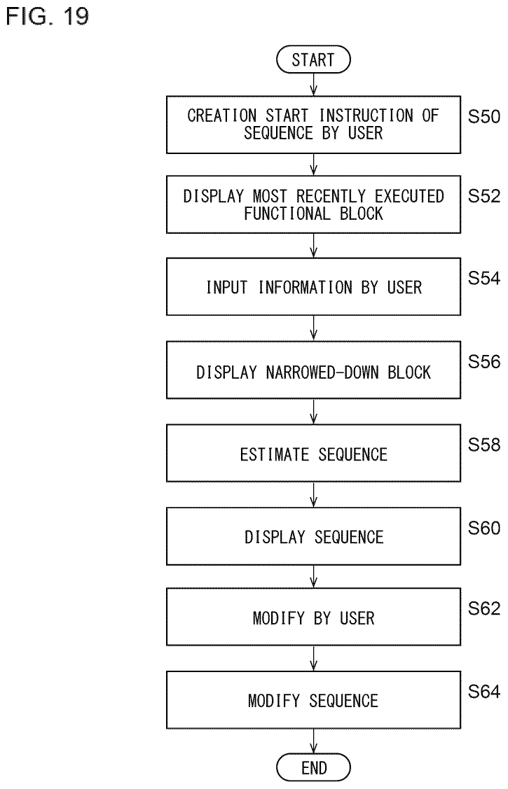

FIG. 19 is a flowchart showing a procedure for creating a block sequence by the appliance control system 1000. The creation start instruction of the functional block sequence 120 by the user is input to the information processing apparatus 400 via the user apparatus 150 (S50). The information processing apparatus 400 causes the user apparatus 150 to display a most recently executed functional block 110 (S52). The information is input by the user to the information processing apparatus 400 via the user apparatus 150 (S54). The information processing apparatus 400 causes the user apparatus 150 to display the functional blocks 110 narrowed down by the user (S56). The information processing apparatus 400 estimates the functional block sequence 120 based on the narrowed-down functional block 110 (S58), and causes the user apparatus 150 to display the functional block sequence 120 (S60). The information processing apparatus 400 receives the modification by the user via the user apparatus 150 (S62), and modifies the functional block sequence 120 (S64).

According to the present embodiment, since the functional block sequence 120 in which the first-type block and the second-type block are arranged in the order of operation is estimated based on the received information related to the first-type block, it is possible to easily create the control content also including the human intervention. In addition, in a case where the modification instruction for the estimated functional block sequence 120 is received, the functional block sequence 120 is modified, and thus, it is possible to easily create the functional block sequence 120 that meets the user's desire. In addition, it is not necessary to plan the cooking systematically for creating the functional block sequence 120, and the functional block sequence 120 can be easily created only by selecting the functional blocks 110 from one's own cooking history.

In addition, if the information related to the functional block 110 corresponding to one recipe among the plurality of recipes is selected from the execution history, the functional block sequence 120 is estimated based on the selected functional block 110. Therefore, even if the plurality of recipes is intermingled in the execution history, the functional block sequence 120 for a desired recipe can be created. Further, the sample of the functional block sequence 120 is acquired by referring to the sample DB 470 based on the pattern in which the functional blocks 110 are arranged, and the functional block sequence 120 is estimated using the sample, so that the functional blocks 110 related to the operation of the person can be added. In addition, the sample of the functional block sequence 120 is acquired by referring to the sample DB 470 based on the received information related to the recipe, and the functional block sequence 120 is estimated using the sample, so that the functional blocks 110 related to the operation of the person can be added.

An overview of one aspect of the present disclosure is as follows. An information processing method according to one aspect of the present disclosure is an information processing method in which a first-type block defined in a functional unit executable by an appliance (100) and a second-type block defined in a unit of operation to be executed by a person are defined, the information processing method including: a step of receiving information related to the first-type block executed by the appliance (100); a step of estimating a block sequence in which the first-type block and the second-type block are arranged in an order of operation based on the received information related to the first-type block; and a step of modifying the block sequence in a case of receiving an instruction to modify the estimated block sequence.

The method further includes a step of selecting information related to the first-type block corresponding to one recipe among a plurality of recipes from the received information related to the first-type block. In the estimation step, the block sequence may be estimated based on the selected information related to the first-type block.

In the estimation step, a sample of the block sequence may be acquired by referring to a storage region in which the sample of the block sequence for each of the plurality of recipes is stored based on a pattern in which the first-type block is arranged, and the block sequence may be estimated based on the acquired sample of the block sequence and the information related to the first-type block.

The method further includes a step of receiving information related to an executed recipe. In the estimation step, the sample of the block sequence may be acquired by referring to a storage region (470) in which the sample of the block sequence for each of the plurality of recipes is stored based on the received information related to the recipe, and the block sequence may be estimated based on the acquired sample of the block sequence and the information related to the first-type block.

Another aspect of the present disclosure is an information processing apparatus (400). The apparatus is an information processing apparatus (400) in which a first-type block defined in a functional unit executable by an appliance (100) and a second-type block defined in a unit of operation to be executed by a person are defined, the information processing apparatus (400) including: a receiver (420) structured to receive information related to the first-type block executed by the appliance (100); an estimator (424) structured to estimate a block sequence in which the first-type block and the second-type block are arranged in an order of operation based on the received information related to the first-type block; and a modifier (426) structured to modify the block sequence in a case of receiving an instruction to modify the estimated block sequence.

The present disclosure has been described above based on the embodiments. It is to be understood by a person skilled in the art that the embodiments are examples, various modifications can be made to combinations of the respective components or the respective processing processes, and such modifications are also within the scope of the present disclosure.

What is claimed is:

1. An information processing method in which a first-type block defined in a functional unit executable by an appliance and a second-type block defined in a unit of operation to be executed by a person are defined, the information processing method comprising:
receiving information related to the first-type block executed by the appliance;
estimating a block sequence in which the first-type block and the second-type block are arranged in an order of operation based on the received information related to the first-type block; and
modifying the block sequence in a case of receiving an instruction to modify the estimated block sequence.

2. The information processing method according to claim 1, further comprising
selecting information related to the first-type block corresponding to one recipe among a plurality of recipes from the received information related to the first-type block, wherein
in the estimating, the block sequence is estimated based on the selected information related to the first-type block.

3. The information processing method according to claim 1, wherein in the estimating, a sample of the block sequence is acquired by referring to a storage region in which the sample of the block sequence for each of the plurality of recipes is stored based on a pattern in which the first-type block is arranged, and the block sequence is estimated based on the acquired sample of the block sequence and the information related to the first-type block.

4. The information processing method according to claim 1, further comprising
receiving information related to an executed recipe, wherein
in the estimating, a sample of the block sequence is acquired by referring to a storage region in which the sample of the block sequence for each of the plurality of recipes is stored based on the received information related to the recipe, and the block sequence is estimated based on the acquired sample of the block sequence and the information related to the first-type block.

5. An information processing apparatus in which a first-type block defined in a functional unit executable by an appliance and a second-type block defined in a unit of operation to be executed by a person are defined, the information processing apparatus comprising:
a receiver structured to receive information related to the first-type block executed by the appliance;
an estimator structured to estimate a block sequence in which the first-type block and the second-type block are arranged in an order of operation based on the received information related to the first-type block; and
a modifier structured to modify the block sequence in a case of receiving an instruction to modify the estimated block sequence.

6. A program in which a first-type block defined in a functional unit executable by an appliance and a second-type block defined in a unit of operation to be executed by a person are defined, the program causing a computer to:
receive information related to the first-type block executed by the appliance;
estimate a block sequence in which the first-type block and the second-type block are arranged in an order of operation based on the received information related to the first-type block; and
modify the block sequence in a case of receiving an instruction to modify the estimated block sequence.
